(19) United States
(12) Patent Application Publication
(10) Pub. No.: US 2005/0282487 A1
(43) Pub. Date: Dec. 22, 2005

(54) Device and method for directly carrying cooled or heated air to the backseat of a car

(76) Inventors: Dan Hecht, Tel Aviv (IL); Silvio Hecht, Ashkelon (IL)

Correspondence Address: DR. MARK FRIEDMAN LTD.;C/o Bill Polkinghorn, 9003 Florin Way, Upper Marlboro, MD, 20772, US

(21) Appl. No.: 11/062,870

(22) Filed: Feb. 23, 2005

(30) Foreign Application Priority Data
Jun. 22, 2004 (IL) 162667

(51) Int. Cl. F24F 7/013

(52) U.S. Cl. 454/306; 454/202

(57) ABSTRACT

A device for directly carrying a portion of the air produced by the air conditioner or heater of a car and released to the car interior by a number of grills located on the dashboard of the car. The device includes an expandable sleeve to be attached to a grill located of the car dashboard. The sleeve has two open ends and one or more openings so that some of the air produced by the air conditioner or heater released from the grill enter the sleeve, causing it to expend out from the grill, so that the air is conveyed through the sleeve and out of the openings in the sleeve and out the other end of the sleeve.

### FIELD OF THE INVENTION

The present invention relates generally to the field of accessory devices for cars. More specifically, the present invention relates to a simple to use, but highly-effective device for carrying a portion of the air produced by the air conditioner or heater of a car directly to the backseat of said car. The present invention also relates to a method for use thereof.

### BACKGROUND OF THE INVENTION

In most cars, cooled or heated air is released to the interior of the car through a number of grills located on the dashboard of the car. Normally, there are four grills, and the central two grills are intended to provide cooled or heated air to the backseat of the car. In actuality though, there tends to be a big temperature difference (when the heat or air conditioning is functioning) between the front seat and the backseat because the cooled/heated air does not satisfactorily reach the backseat. Individuals sitting in the backseat do not gain the same benefit from the heater or air conditioner, and this leads to uncomfortable passengers, nagging children, and arguments over raising or lowering the thermostat. While some cars feature divided air conditioners and heaters, where a certain number of grills are located in the back of the car, the majority of cars are not equipped with this feature. Thus, there is a need for a simple and easy way to convey air produced by the air conditioner or heater of a car directly to the backseat such that passengers in the backseat can enjoy the heated or cooled air just as much as those passengers in the front seat.

The inventor of the present invention has developed a novel and uncomplicated device for providing “divided” air conditioning and heating to cars that do not have already-existing grills in the backseat.

It is thus the primary object of the present invention to provide an inexpensive and easy-to-use device for conveying a portion of the air produced by the air conditioner or heater (or fan) of a car and released through grills located on the dashboard of the car directly to the backseat of said car. The device of the present invention does not require the use of any electricity, and it may be used and re-used on an as-needed basis. Moreover, the device is made from inexpensive materials and is designed for any virtually any type of vehicle.

It is also an object of the present invention to provide a method for the use of said device.

These and other objects of the present invention will become more readily apparent from the summary of the invention and the detailed description of the drawings that follow.

### SUMMARY OF THE INVENTION

While the device of the present invention is described in reference to a “car”, it is appreciated that the device could be used for any type of vehicle such as a truck, minivan, or station wagon, suffering from the above-described problem.

The present invention relates to a device for directly carrying a portion of the air produced by the air conditioner or heater of a car and released to the car interior by a plurality of grills located on the dashboard of the car. The device comprises an expandable sleeve operably attached to a grill located on the dashboard of a car. The sleeve preferably has a generally circular shape, with a first open end and a second end having at least one opening (the second end may either be completely open, similar to the first end of the sleeve, or, more preferably, it may have one or more smaller openings). Initially, when not in use, the sleeve is in a collapsed (or folded), non-expanded state. When air that is produced by the air conditioner or heater of the car is released from the grill (to which the sleeve is operably attached), at least a portion of the heated or cooled air enters the sleeve through the first end thereof, causing the sleeve to expand out from the grill, such that air is conveyed through the sleeve and out through said at least one opening in said second end of the sleeve. The sleeve may expand to any appropriate maximal length such that the air exiting from the second end of the sleeve is thus directly delivered to the backseat of the car.

It is appreciated that the sleeve may receive all of the air released from the grill to which it is operably attached, or it may be attached such that only a portion of the air is passed through the sleeve, and the remainder is released to the front seat of the car. It is also appreciated that, should it be desired, more than one of the devices of the present invention may be employed at the same time, on different grills of the dashboard.

The sleeve may be attachable directly to the grill. Alternatively, and according to preferred embodiments of the present invention, the sleeve is operably attachable to the grill via a substantially hollow holder. The holder is adapted for being attached to the grill by the user. When attached, the sleeve is preferably positioned substantially inside of the holder, and in a non-expanded state. The first end of the sleeve is attached through any appropriate means (preferably, adhesive means) to the interior or the exterior of the holder. When the air conditioner or heater is operated, the sleeve becomes automatically expanded due to the inflow of air released from the grill, so as to carry air directly to the backseat of the car. Air thus enters the sleeve though the first end and exits the sleeve through the second end thereof.

Preferably, the holder is attached to the grill via at least one clip. Other appropriate means may also be employed, as are known in the art.

According to preferred embodiments of the present invention, the holder has a generally cylindrical shape. Alternatively, the holder has a generally square shape. Other appropriate shapes may also be employed, such as those that conform exactly to certain dashboard grills.

Moreover according to preferred embodiments of the present invention, the holder is formed from a rigid plastic material.

Further according to preferred embodiments of the present invention, the device also comprises a cover located on the exterior-facing end of the holder. The cover is adapted to be removed by the user, either by hand, or through any other appropriate means (for example, a button operably coupled to the cover) just prior to usage.

Additionally according to preferred embodiments of the present invention, the sleeve is formed from plastic, nylon, or any other appropriate material.

When the air conditioner or heater is shut off, the user can simply re-collapse the sleeve to the inside of the holder for subsequent use. The holder can also be detached from the grill for later use. Alternatively, the sleeve may be designed to be disposable, such that a new sleeve is employed for each usage of the device. In some preferred embodiments, the sleeve is designed to collapse back into the holder in an automatic manner when the air is shut off.

While no electrical means are required for using the device of the present invention, it is appreciated that the device could be easily adapted to work through an electric medium.

The present invention also relates to method for directly carrying air produced by the air conditioner or heater of a car and released through a plurality of grills located on the dashboard of said car, using the device described above. The method comprises:
(a) attaching the holder of the device to a grill of a car dashboard;
(b) operating the air conditioner or heater of the car such that cooled or heated air thereby produced is released through the grill, thus entering into the sleeve of the device through the first end of the sleeve, and causing the sleeve to expand to a maximum length, thereby resulting in the release of cooled or heated air from the second end of the sleeve.

The sleeve may be designed to expand to any appropriate maximal length. For larger cars or minivans, a longer sleeve may be used, whereas for smaller compact cars, a correspondingly smaller sleeve may be employed.

According to preferred embodiments of the present invention, the method further comprises attaching the holder of a second device to a second grill of the dashboard.

Additionally according to preferred embodiments of the present invention, the method further comprises shutting off the air conditioner or heater and folding the sleeve back inside of the holder for subsequent usage.

The present invention also relates to a method for directly providing cooled or heated air released into the interior of a car through at least one grill located on the dashboard of the car to passengers in the backseat of the car. The method comprises attaching an expandable sleeve to at least one of the grills located on the dashboard of the car. The sleeve has a first open end and a second end having at least one opening, such that when air produced by the air conditioner or heater of the car is released from the grill, at least a portion of the air enters the sleeve through the first end thereof, causing the sleeve to expand out from the grill, such that air is conveyed through the sleeve and out through said at least one opening in the second end of the sleeve.

### BRIEF DESCRIPTION OF THE DRAWINGS

FIG. 1 represents a schematic view of a device for carrying a portion of the air produced by the air conditioner or heater of a car and released to the car interior by a plurality of grills located on the dashboard of the car, according to a first preferred embodiment of the present invention. The sleeve of the device is shown in the non-expanded configuration.

FIG. 2 represents a schematic view of the device of FIG. 1, with the sleeve in the expanded position as a result of operation of the air conditioner or heater of the car.

FIG. 3 represents an isometric view of a device for carrying a portion of the air produced by the air conditioner or heater of a car and released to the car interior by a plurality of grills located on the dashboard of the car, according to a second preferred embodiment of the present invention. The sleeve of the device is shown in the non-expanded configuration.

FIG. 4 represents an isometric view of the device of FIG. 3, attached to the grill of the dashboard of a car.

FIG. 5 is identical to FIG. 4, except that the sleeve of the device is shown in the expanded configuration.

### DETAILED DESCRIPTION OF THE DRAWINGS

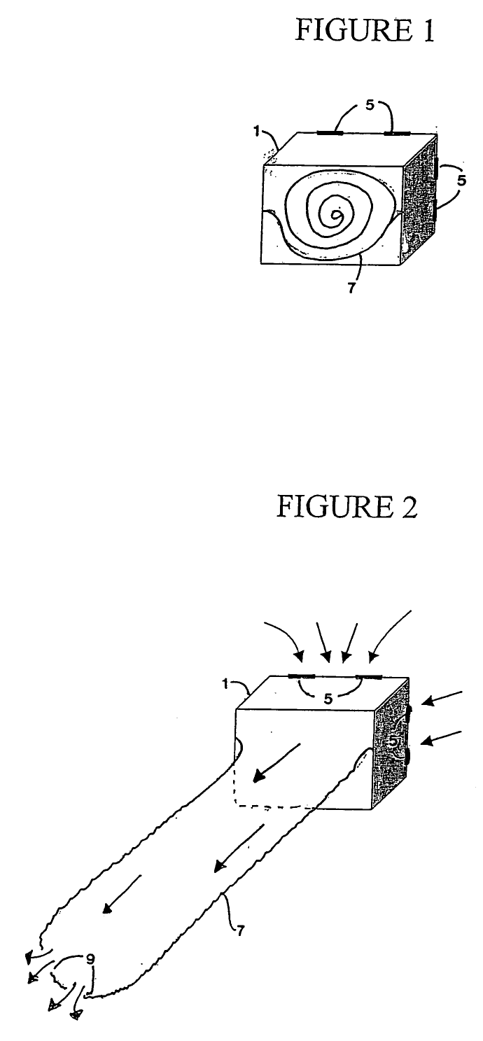

Referring first to FIG. 1, according to some preferred embodiments of the present invention, the device includes a substantially hollow holder (1) that is attachable to the grill of a car dashboard. A plurality of clips (5) may be employed for allowing attachment of the holder to the grill, though other appropriate means are possible as well. It is appreciated that such clips allow the device to be attached in a fast, convenient, and efficient manner to the grill by the user of the device. When the device is no longer required, the holder (1) can be easily removed from the grill by undoing of the clips (5). The holder (1) is preferably formed from any appropriate rigid or partially rigid material such as hard plastic. In some preferred embodiments (not shown), the holder may have a cover that is removed just prior to usage of the device. Said cover may be removed by the hand of the user or through other suitable means, such as a button that is coupled to the holder.

Contained substantially inside the holder (1) is an expandable sleeve (7), formed from a flexible and expandable material such as plastic or nylon. The first end of the sleeve (7) is secured, preferably to the inside of the holder (1), and preferably via an adhesive material such as glue. Said first end is open, so as to allow for the entry of cooled or heated air into the sleeve (7) when said air is released into the car through the corresponding grill. As seen in FIG. 2, when air fills the sleeve (7), the sleeve automatically becomes expanded out of the holder (1) and away from the dashboard and grill. The sleeve (7) is extended by the air to a maximal length, so as carry air directly to the backseat of the car. The sleeve (7) may be designed in various lengths, so as to be appropriate for different size cars. At second of the sleeve, there are preferably a plurality of openings (9), through which the air exists when the air reaches the end of the sleeve (7). The path of cooled or heated air is indicated in both Figures by the arrows. It is appreciated that in other preferred embodiments, the second of the sleeve (7) may be completely open, like the first end of the sleeve (7).

It is appreciated that following usage of the device, the user simply re-folds the sleeve (7) back into the holder for subsequent use (in some embodiments, the sleeve may be disposable, and a new sleeve may be attached for later uses).

It is thus appreciated that the device of the present invention allows for “splitting” of the cooled or heated air produced by a car to the front and backseat of the car in an efficient, easy-to-use, and inexpensive manner. Further adaptations and modifications of the device of the present invention are possible, without departing from the scope of the invention, as set out in the claims. For example, while the device does not require any electricity to use, it could be easily adapted for allowing a user to employ the device through an electric medium. Also, the sleeve may be adapted for being clipped to the ceiling of the car, incase the expanded sleeve is bothersome to the driver of the car.

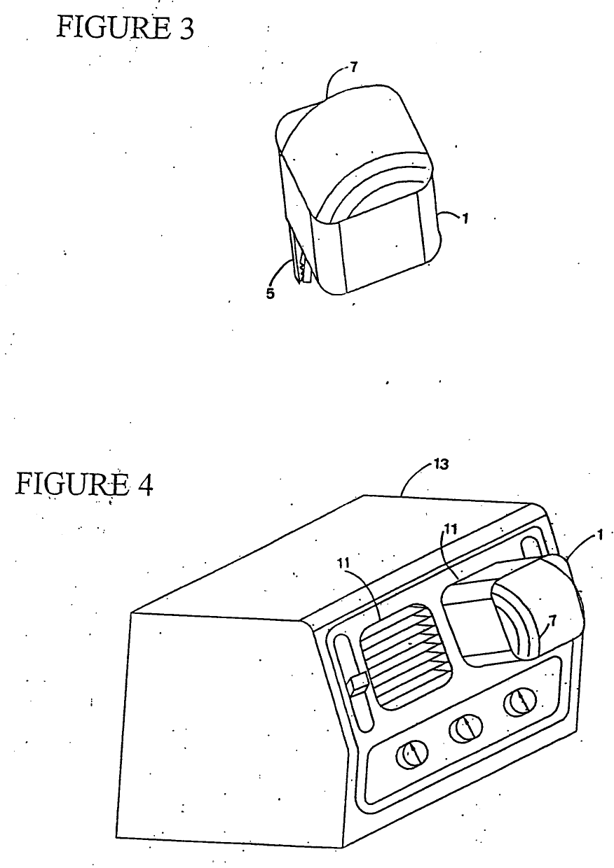

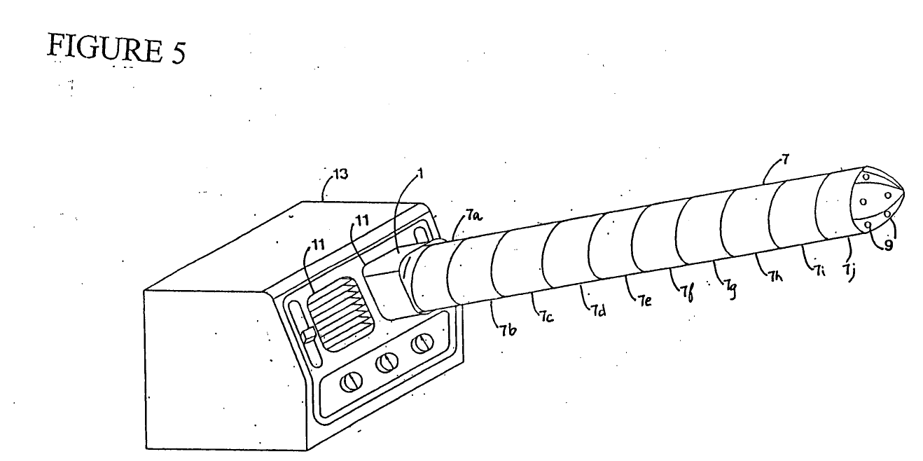

Reference will now be made to FIGS. 3, 4, and 5, and to another preferred embodiment of the present invention. This preferred embodiment is similar to that of FIGS. 1 and 2, except that the sleeve (7) is adapted to collapse in an “automatic” manner when the air conditioning or heater of the car is shut off. The sleeve is designed similar to the popular children's toy that is blown into to cause expansion and subsequently collapses back to its original configuration when the child stops blowing into it. The sleeve (7) has a plurality of sections (7a, 7b, 7c, etc . . . ) that fit inside one another when the device is not in use. When the air conditioner or heater of the car is turned on, air causes the sleeve to expand from the configuration shown in FIG. 4, to the configuration shown in FIG. 5, so as to carry heated or cooler air to the backseat of the car. When the air is shut off, the sections (7a-7j) of the sleeve (7) fold into one another such that the sleeve (7) collapses automatically back inside the holder (1).

Also in FIGS. 4 and 5, the attachment of the device to one of the grills (11) of a portion of the dashboard (13) of a car can be seen. The device shown is attached to the right grill of two of the central grills (11) of the dashboard (13). It is appreciated that a second device may be attached to the left grill as well, or to grills located near the windows of the front seat of the car (not shown).

1. A device for directly carrying a portion of the air produced by the air conditioner or heater of a car and released to the car interior by a plurality of grills located on the dashboard of the car, comprising an expandable sleeve operably attachable to a grill located on the dashboard of a car, wherein said sleeve has a first open end and a second end having at least one opening, such that when air produced by the air conditioner or heater of the car is released from said grill, at least a portion of said air enters the sleeve through said first end thereof, causing said sleeve to expand out from said grill, such that air is conveyed through said sleeve and out through said at least one opening in said second end of said sleeve.

2. A device according to claim 1, wherein the sleeve is attachable to the grill via a substantially hollow holder, said holder attached to said grill and said sleeve being positioned substantially inside said holder.

3. A device according to claim 2, wherein the holder has a generally cylindrical shape.

4. A device according to claim 2, wherein the holder has a generally square shape.

5. A device according to claim 2, wherein the holder is formed from a hard plastic material.

6. A device according to claim 2, wherein the holder is attachable to said grill by means of a clip.

7. A device according to claim 2, further comprising a cover located on the exterior-facing end of said holder.

8. A device according to claim 2, wherein the first end of the sleeve is attached to the holder by an adhesive.

9. A device according to claim 2, wherein the first end of the sleeve is attached to the interior of the holder.

10. A device according to claim 2, wherein the sleeve is adapted for being collapsed automatically into the holder following usage of the device.

11. A device according to claim 1, wherein the sleeve is formed from an expandable flexible material.

12. A device according to claim 11, wherein the sleeve is formed from a material selected from plastic or nylon.

13. A device according to claim 1, wherein the second end of the sleeve comprises a plurality of openings.

14. A method for directly carrying air produced by the air conditioner or heater of a car and released through a plurality of grills located on the dashboard of said car, using the device as described in claim 2, comprising;
(a) attaching the holder of said device to a grill of the dashboard;
(b) operating the air conditioner or heater of the car such that cooled or heated air produced by said air conditioner or heater is released through said grill, thereby entering into the sleeve of the device through the first end of the sleeve, causing said sleeve to expand to a maximum length, and causing air to be released from the openings in the second end of the sleeve.

15. A method according to claim 14, further comprising attaching the holder of a second device to a second grill of the dashboard.

16. A method according to claim 14, further comprising shutting off said air conditioner or heater and folding said sleeve back inside of said holder for subsequent usage.

17. A method for directly providing cooled or heated air released into the interior of a car through at least one grill located on the dashboard of said car to passengers in the backseat of said car, comprising attaching an expandable sleeve to at least one of the grills located on the dashboard of said car, said sleeve having a first open end and a second end having at least one opening, such that when air produced by the air conditioner or heater of the car is released from said grill, at least a portion of said air enters the sleeve through said first end thereof, causing said sleeve to expand out from said grill, such that air is conveyed through said sleeve and out through said at least one opening in said second end of said sleeve.
